(19) United States
(12) Patent Application Publication
(10) Pub. No.: US 2005/0147939 A1
(43) Pub. Date: Jul. 7, 2005

(54) Plastic capsule for the storage and delivery of dental material

(75) Inventor: Hans-Joachim Zumkeller, Weilrod (DE)

Correspondence Address: NORRIS, MCLAUGHLIN & MARCUS, P.A., 875 THIRD AVE, 18TH FLOOR, NEW YORK, NY, 10022, US

(73) Assignee: Heraeus Kulzer GmbH & Co. KG, Hanau (DE)

(21) Appl. No.: 10/402,188

(22) Filed: Mar. 28, 2003

(30) Foreign Application Priority Data
Apr. 26, 2002 (DE) 102 18 859.9

(51) Int. Cl. A61C 5/04

(52) U.S. Cl. 433/90

(57) ABSTRACT

Plastic capsule for the storage and delivery of dental material, wherein the capsule is made of polyoxymethylene, and the use of said capsule for highly viscous dental materials.

The invention relates to a plastic capsule for the storage and delivery of dental material, and a use for said capsule.

U.S. Pat. No. 5,100,320 discloses a type of capsule for the delivery of dental material, wherein different plastic materials with and without filler materials are listed for use in the production of the capsules. Suitable plastics named include polyolefins such as polypropylene, polyisobutylene, and polyethylene. Polystyrene and polyamides are also disclosed as suitable.

Plastic capsules are also known from U.S. Pat. No. 5,707,234 or EP 0 744 161 B1. The capsules described therein are equipped with an angled delivery nozzle on a small cylindrical tube, which has a cylindrical inner diameter, and an annular groove on its outer diameter to accommodate a snap-on closure cap. The positioning of the delivery nozzle on the capsule is such that the lengthwise axis of the small cylindrical tube does not intersect with or touch the nozzle. Further, these publications, as in EP 0 063 891 B2, also show capsules in which the inner diameter of the delivery nozzle is conically tapered. A similar arrangement is also disclosed in EP 0 272 488 A1.

U.S. Pat. No. 6,261,094 discloses a plastic capsule for the delivery of highly viscous dental materials, which may be equipped with an inner coating made, for example, of Teflon or silicone, for the purpose of reducing friction. Plastics named as suitable for use in this capsule include polypropylene, nylon, and Delrin. The delivery opening of the capsule is directly connected to a small cylindrical tube, wherein the ratio of the inner diameter of the small cylindrical tube D to the inner diameter of the delivery opening d ranges from 0.6 to 1.

EP 1 010 400 A2 shows a capsule designed to deliver low-viscosity dental materials, with an angled delivery opening and a porous, elastically deformable body within the capsule channel. The low-viscosity dental material is pushed out of the deformable body with a plunger.

EP 0 727 191 A2 discloses a plastic container for the storage and delivery of a dental material, comprising a circular cylindrical cartridge and a delivery nozzle in the form of a small, rigid, curved tube that tapers in the direction of delivery. The curve of the delivery nozzle has the shape of a circular arc, wherein the shape of the inner cross-section is circular throughout. The cartridge and the delivery nozzle are plastic components, wherein the cartridge is preferably opaque, especially black, allowing it to hold light-sensitive materials. The delivery nozzle is preferably colored to identify the contents.

A similar arrangement is disclosed in EP 0 220 551 B1, which shows an application nozzle made of thermoplastic plastic for a dental material, which has a small, curved delivery tube. The ratio of the inner diameter of the nozzle to the inner diameter of the delivery opening is less than 3:1. Polypropylene, polyethylene, and polyamide are disclosed as suitable plastic materials for the nozzle.

Common to all known capsules is the fact that the materials contained in the capsule are pushed out via a plunger, frequently for a direct application into a dental cavity. Especially with paste-like materials, even small changes in the shape of the cross-section of the capsule can have a great influence on the force required to push the material out. The higher the viscosity of the material to be delivered, the more serious this influence is.

The object of the invention is thus to prepare a capsule for the storage and delivery of dental material, which requires less pressure to deliver the material than with known capsules, especially in the case of highly viscous materials. Further, a preferred use for a capsule of this type shall be provided.

The problem of the capsule is solved in that the capsule is made of polyoxymethylene. Using this plastic surprisingly results in up to 20% less pressure required to deliver the material, as compared with known capsule materials.

Polyoxymethylene is chemically resistant to organic solvents such as ethanol or methylmethacrylate, and does not become discolored in their presence. This is particularly important in view of the fact that dental materials contained in these types of capsules frequently contain these organic solvents, and in view of a necessary exterior cleaning of the capsule after use. In addition, polyoxymethylene can be permanently marked using a laser. This enables a high degree of automation in the production of the capsule specified in the invention, thus decreasing production costs.

With further optimization of the inner shape of the capsule, the amount of pressure required to deliver the material can be further reduced. In this, it has proven effective for the capsule to comprise three capsule sections that are inseparably attached to one another, wherein
a first capsule section is formed by a small cylindrical tube that is circular in cross-section, wherein the first capsule section has a first end and a second end, and wherein a circular flange is positioned at the first end, and wherein
a second capsule section in the form of a small tube is attached to the second end of the first capsule section, with its inner diameter continuously decreasing in size starting from the second end of the first capsule section, wherein the inner diameters of the first capsule section and the second capsule section are equal in the area of the second end of the first capsule section, and wherein
a third capsule section is formed by a delivery nozzle having a cylindrical delivery channel, wherein the delivery nozzle is attached to the second capsule section in such a way that the lengthwise axis of the delivery channel is tilted at an angle α, measuring between 30° to 60° from the lengthwise axis of the first capsule section, and that the delivery channel has a continuous transition to the inner contour of the second capsule section, wherein the lengthwise axis of the first capsule section at the end of the delivery channel that borders the second capsule section touches the circumference of the cylindrical delivery channel at a single point.

The formation of dead corners, which cause the direction of flow of the dental material inside the capsule to change, thus necessitating greater pressure to deliver the material, is prevented. By making the inside shape of the capsule round, the shear forces acting on the dental material are minimized. Especially in the case of highly viscous dental materials, a separation of the solid and liquid phases of the dental material, such as frequently occurs in known capsules whose inside contours include sharp edges or stepped areas, can be effectively prevented.

A further advantage of this embodiment is the possibility of automatic filling, which would further contribute to decreasing production costs.

To minimize the amount of pressure required to deliver the material, it has proven effective for the lengthwise axis of the delivery channel to be tilted at an angle α=40° from the lengthwise axis of the first capsule section.

With this arrangement, the diameter of the delivery channel preferably measures between 2.2 mm and 2.6 mm.

For the inner diameter of the small, cylindrical tube, values ranging from 4.0 mm to 5.0 mm are preferred.

To make it easier to position the delivery nozzle over a dental cavity, and to enable the most precise delivery of the dental material possible, it has proven effective for the wall thickness of the delivery nozzle to decrease in the direction of delivery.

Especially in the case of light-sensitive dental materials, or materials that are hardened via radiant exposure, it is preferable for the capsule to be opaque, i.e., impervious to light, in order to prevent any influence, e.g., a hardening of light-sensitive dental materials, in the area of the delivery nozzle. A cap prevents air from reaching the dental material and drying it out, and prevents any of the material from leaking out through the delivery nozzle.

A use of the capsule specified in the invention for the storage and delivery of highly viscous dental material is ideal. Specifically, the capsule is used for a dental material having a viscosity level of ≦10 MPas.

### BRIEF DESCRIPTION OF THE DRAWINGS

The FIGS. 1, 1a, and 2 are intended to further elucidate the capsule specified in the invention by way of example.

FIG. 1 shows a longitudinal section through a capsule made of polyoxymethylene.

FIG. 1a shows the section S from FIG. 1.

FIG. 2 shows a longitudinal section through a capsule pursuant to FIG. 1, with a plunger and a cap.

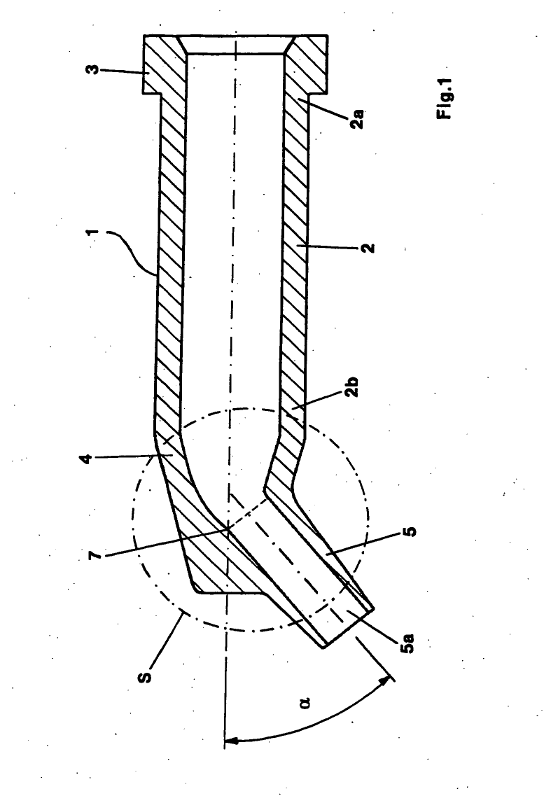

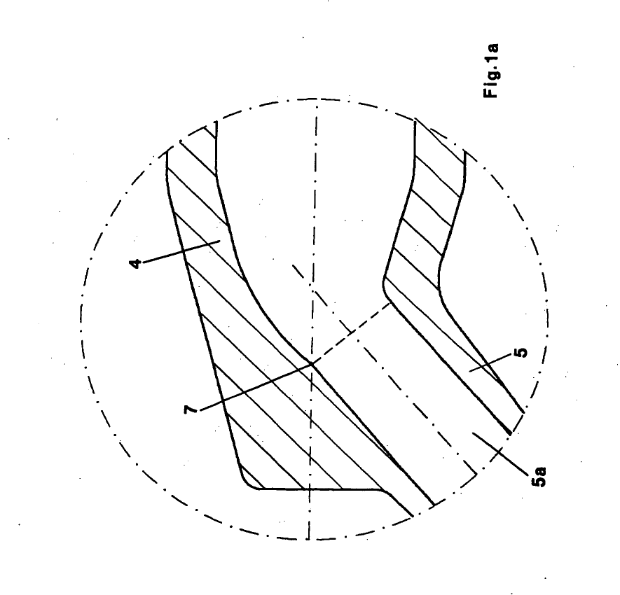

FIG. 1 shows a longitudinal section through a capsule 1 made of polyoxymethylene, comprising three capsule sections that are inseparably attached to one another, wherein a first capsule section 2 is formed by a small cylindrical tube that is circular in its cross-section. The first capsule section 2 has a first end 2a and a second end 2b, wherein a circular flange 3 is positioned at the first end 2a. A second capsule section 4 in the form of a small tube is attached to the second end 2b of the first capsule section 2, with its inner diameter continuously decreasing in size starting from the second end 2b of the first capsule section 2. The inner diameters of the first capsule section 2 and the second capsule section 4 are equal in the area of the second end 2b of the first capsule section 2. A third capsule section 5 is formed by a delivery nozzle having a cylindrical delivery channel 5a, wherein the delivery nozzle is attached to the second capsule section 4 in such a way that the lengthwise axis of the delivery channel 5a is tilted at an angle α, measuring between 30° to 60° from the lengthwise axis of the first capsule section 2. The delivery channel 5a has a continuous transition to the inner contour of the second capsule section 4, wherein the lengthwise axis of the first capsule section 2 at the end of the delivery channel 5a that borders the second capsule section 4 touches the circumference of the cylindrical delivery channel 5a at a single point 7. The continuous transition from the inner contour of the second capsule section 4 to the delivery channel 5a is realized in that the hollow space in the second capsule section 4 does not extend beyond the point 7—viewed perpendicular to the lengthwise axis of the first capsule section 2—but rather ends directly at point 7. A dashed line indicates the end of the cylindrical delivery channel 5a in the area of transition to the second capsule section 4. Beyond this dashed line, the inner diameter of the second capsule section deviates from the shape of the cylinder.

FIG. 1a shows the section S from FIG. 1. Here it is clear that the lengthwise axis of the first capsule section 2 at the end of the cylindrical delivery channel 5a that borders the second capsule section 4, touches the circumference of the cylindrical delivery channel 5a at a single point 7. This and the rounding of the inner contour at the area of transition between the cylindrical delivery channel 5a and of the inner diameter of the second capsule section 4, in addition to the use of polyoxymethylene as the capsule material, ensure a further reduction in the amount of pressure required to deliver the material.

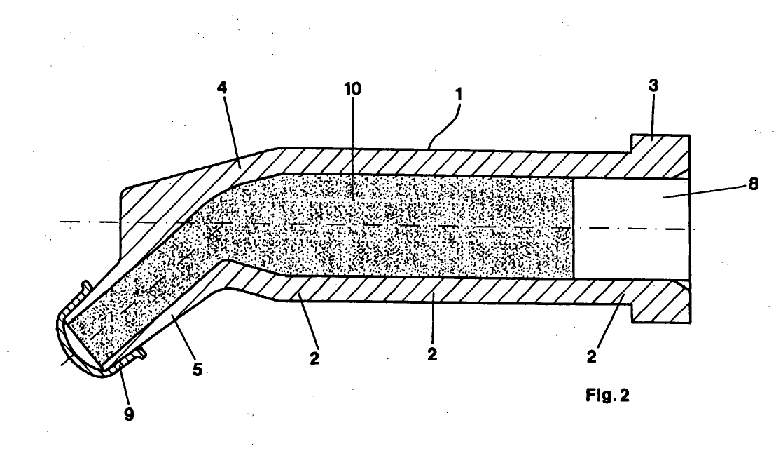

FIG. 2 shows the capsule from FIG. 1 with a plunger 8 in the small, cylindrical tube of the first capsule section 2, and a cap 9, which seals the delivery channel 5a of the third capsule section 5 and/or the delivery nozzle. In the small, cylindrical tube of the first capsule section 2 is a paste-like dental material 10, which can be pushed in the direction of the delivery nozzle via the plunger 8, and, if the cap 9 is opened, can be pushed out through the delivery channel 5a. The geometries of the plunger 8 and the cap 9 may, of course, be different, as long as their functionality is not adversely affected.

1. Plastic capsule for the storage and delivery of dental material, wherein the capsule (1) is made of polyoxymethylene.

2. Capsule in accordance with to claim 1, wherein the capsule (1) comprises three capsule sections that are permanently attached to one another, said three capsule sections being
a first capsule section (2) which is formed by a small cylindrical tube that is circular in cross-section, said first capsule section (2) having a first end (2a) and a second end (2b), and a circular flange (3) positioned at the first end (2a), and
a second capsule section (4) in the form of a small tube which is attached to the second end (2b) of the first capsule section (2), with its inner diameter continuously decreasing in size starting from the second end (2b) of the first capsule section (2), the inner diameters of the first capsule section (2) and the second capsule section (4) being equal in the area of the second end (2b) of the first capsule section (2), and
a third capsule section (5) formed by a delivery nozzle having a cylindrical delivery channel (5a), the delivery nozzle being attached to the second capsule section (4) with the lengthwise axis of the delivery channel (5a) being tilted at an angle α, measuring between 30° to 60° from the lengthwise axis of the first capsule section (2), the delivery channel (5a) having a continuous transition to the inner contour of the second capsule section (4), with the lengthwise axis of the first capsule section (2) at the end of the delivery channel (5a) that borders the second capsule section (4) touching the circumference of the cylindrical delivery channel (5a) at a single point.

3. Capsule in accordance with to claim 2, wherein the angle α=40°.

4. Capsule in accordance with claim 2, wherein the diameter of the delivery channel (5a) measures between 2.2 mm and 2.6 mm.

5. Capsule in accordance with claim 3, wherein the diameter of the delivery channel (5a) measures between 2.2 mm and 2.6 mm.

6. Capsule in accordance with claim 2, wherein the inner diameter of the small cylindrical tube measures between 4.0 mm and 5.0 mm.

7. Capsule in accordance with claim 3, wherein the inner diameter of the small cylindrical tube measures between 4.0 mm and 5.0 mm.

8. Capsule in accordance with claim 2, wherein the wall thickness of the delivery nozzle (5a) decreases in the direction of delivery.

9. Capsule in accordance with claim 3, wherein the wall thickness of the delivery nozzle (5a) decreases in the direction of delivery.

10. Capsule in accordance with claim 1, wherein the polyoxymethylene is opaque.

11. Capsule in accordance with claim 2, wherein the polyoxymethylene is opaque.

12. Capsule in accordance with claim 1, wherein the delivery nozzle is sealed with a cap (9).

13. Capsule in accordance with claim 2, wherein the delivery nozzle is sealed with a cap (9).

14. Capsule in accordance with claim 12, wherein the cap (9) is elastically deformable.

15. Capsule in accordance with claim 13, wherein the cap (9) is elastically deformable.

16. Method for the storage and delivery of dental material, which comprises storing and delivering said dental material in the plastic capsule of claim 1
